(19) United States
(12) Patent Application Publication
(10) Pub. No.: US 2015/0379991 A1
(43) Pub. Date: Dec. 31, 2015

(54) INTELLIGENT SOUND SYSTEM/MODULE FOR CABIN COMMUNICATION

(71) Applicant: Airbus Operations GmbH, Hamburg (DE)

(72) Inventor: Holger Frauen, Hamburg (DE)

(21) Appl. No.: 14/754,027

(22) Filed: Jun. 29, 2015

(30) Foreign Application Priority Data
Jun. 30, 2014 (DE) 102014009689.0

(51) Int. Cl. G10L 15/20; G10L 25/84

(52) U.S. Cl. CPC G10L 15/20; G10L 25/84

(57) ABSTRACT

Speech communication on board a transport device. In particular, a method for adapting speech data serving for speech communication on board a transport device, to a computer program for executing the method, to a device for adapting speech data serving for speech communication on board a transport device, and also to a transport device with a device of such a type. An embodiment of the method for adapting speech data serving for speech communication on board a transport device comprises: obtaining information relating to at least one tone property, the information relating to the at least one tone property having been derived from recorded speech data appertaining to a person; and adapting speech data appertaining to the person and serving for speech communication on board the transport device on the basis of the obtained information about the at least one tone property.

### CROSS-REFERENCES TO RELATED APPLICATIONS

This application claims the benefit of the German patent application No. 10 2014 009 689.0 filed on Jun. 30, 2014, the entire disclosures of which are incorporated herein by way of reference.

### BACKGROUND OF THE INVENTION

The present disclosure relates generally to speech communication on board a means of transport. In particular, the present disclosure relates to a method for adapting speech data serving for speech communication on board a means of transport, to a computer program for executing the method, to a device for adapting speech data serving for speech communication on board a means of transport, and also to a means of transport with a device of such a type.

On board means of transport—such as aircraft, buses, trains or ships—spoken announcements are implemented by the personnel when required. Spoken announcements of such a type can be made with the aid of communication systems that are present on board the means of transport. Many of these announcements serve purely for the purpose of providing information to the passengers. One example of this is an announcement made by an aircraft pilot, with which he/she informs the passengers about the flight and associated information such as information about the approximate air route or the weather at the place of arrival. Other announcements may contain information relevant to safety. One example of this is an announcement prior to the start of a flight, with which the passengers are informed about safety instructions. Similar announcements exist on board trains, buses or ships.

It is desirable that the speech communication on board a means of transport is as clear as possible and can be understood well.

### SUMMARY OF THE INVENTION

A first aspect relates to a method for adapting speech data serving for speech communication on board a means of transport. The method includes a step of obtaining information relating to at least one tone property. The information relating to the at least one tone property has been derived from recorded speech data appertaining to a person. The method further includes a step of adapting speech data appertaining to the person and serving for speech communication on board a means of transport on the basis of the information obtained about the at least one tone property.

The means of transport may be, for example, an aircraft, a bus, a train, a ship, or a means of transport of a different type. The obtaining of information relating to the at least one tone property may also be designated as receiving of information relating to the at least one tone property. When it is stated herein that defined data or information are/is transmitted to the device executing the method (or, in short: the device), this transmission may be effected in wireless and/or hard-wired manner with the aid of appropriate communication standards.

The speech communication may be a spoken announcement implemented on board the means of transport and directed towards a plurality of passengers. By virtue of the adaptation of the speech data on the basis of the information relating to the at least one tone property, an improvement of the tone/quality of the speech communication can be achieved. By this means, both spoken announcements having purely informative character and spoken announcements relevant to safety, such as announcements in the case of an emergency, can be understood better and more easily by passengers.

Each of the at least one tone property may be a property, a characteristic or a feature of a voice. One and the same tone property may be variably distinctive, for example, in different persons. Likewise, one tone property of a first person may be equally as distinctive as or similarly distinctive to the corresponding tone property of a second person, whereas another tone property of the first person differs from the corresponding tone property of the second person.

The specific distinctness of the at least one tone property is described herein by the aforementioned information relating to the at least one tone property. Correspondingly, the information relating to the at least one tone property specifies the specific distinctness of the at least one tone property. Different information relating to the at least one tone property accordingly points to a different distinctness of the at least one tone property. Identical information relating to the at least one tone property points to the same distinctness of the at least one tone property.

The at least one tone property may, additionally or alternatively to being influenced by the voice of a person, also be influenced by the language being used. This means that, even in the same person, one and the same tone property may be variably distinctive, depending on the language being used. With the aid of the at least one tone property, one or more persons can be differentiated from one or more other persons. Several persons may have identical, similar or differing instances of distinctness of the same tone property.

In the following, a couple of examples of the at least one tone property will be specified, without being restricted thereto. Accordingly, the at least one tone property may comprise: a frequency range (unit Hz), a fundamental frequency (unit Hz), a dynamic range, a volume level or level (unit dB), a duration (unit s), a degree of modulation, a loudness (unit sone; a 1 kHz tone with level 40 dB has a loudness of N=1 sone), a sharpness (unit acum), a pitch (unit mel or bark; 1 bark=100 mel), a roughness (unit asper), a fluctuation strength (unit vacil), a tone content and/or an impulse content of the recorded speech data appertaining to the person. Items of information about all these tone properties can be used independently or in combination with one another in order to adapt the speech data serving for speech communication.

The method may include a step of adapting the speech data serving for speech communication on board the means of transport such that information relating to the at least one tone property of the speech data serving for speech communication on board the means of transport is at least approximated to the information derived from the recorded speech data appertaining to the person and relating to the at least one tone property. Expressed otherwise, the speech data serving for speech communication on board the means of transport can be adapted in such a manner that information relating to the at least one tone property of the speech data serving for speech communication on board the means of transport (these ‘speech data’ may also be abbreviated as ‘speech-communication data’) is at least approximated to the information derived from the recorded speech data appertaining to the person and relating to the at least one tone property.

In other words, namely using the abbreviation, the speech data serving for speech communication on board the means of transport can, for example, be adapted in such a manner that information relating to the at least one tone property of the speech-communication data is at least approximated to the information derived from the recorded speech data appertaining to the person and relating to the at least one tone property. For example, the speech data serving for speech communication on board the means of transport can be adapted in such a manner that information relating to the at least one tone property of the speech-communication data is at least almost assimilated to the information derived from the recorded speech data appertaining to the person and relating to the at least one tone property.

By virtue of the approximation or assimilation, the at least one tone property of the speech data serving for speech communication may be similarly, or even at least almost identically, distinctive as the at least one tone property derived from the recorded speech data. By virtue of the approximation or assimilation of the information relating to the at least one tone property of the speech-communication data to the information derived from the recorded speech data appertaining to the person, an improvement of the tone/quality of the speech communication can be achieved.

It is, for example, conceivable that the adapting of the speech data appertaining to the person and serving for speech communication on board the means of transport includes at least a step of diminishing noises influencing the at least one tone property. For example, the noises can be at least almost completely removed. By virtue of the diminishing or removal of noises influencing the at least one tone property, the at least one tone property of the speech data serving for speech communication may—after the adaptation—be similarly, or even at least almost identically, distinctive as the at least one tone property derived from the recorded speech data. As a specific configuration, it is conceivable that the noises are at least diminished in such a manner that a step of diminishing noises outside the at least one tone property takes place. As a result, information relating to the at least one tone property can be obtained at least almost completely or can remain at least almost completely uninfluenced, whereas noises lying outside this at least one tone property but nevertheless influencing the at least one tone property are diminished or at least almost completely removed.

By way of example, without being restricted thereto, let a frequency range be mentioned as an example of the at least one tone property. In accord with this example, information that specifies the precise frequency range of the recorded speech data—such as, for example, an initial frequency and a final frequency of the frequency range—can be obtained as information about the at least one tone property. In general, the frequency range of the human voice with the overtones is situated approximately between 80 Hz and 12 kHz. Purely by way of example, for the purpose of illustration it may be assumed that the information relating to a frequency range of the specific recorded speech data appertaining to a defined person specifies a frequency range from 90 Hz to 10 kHz (as information relating to the at least one tone property). Noises lying outside this frequency range can be filtered out by the adaptation, for example by means of a band-pass filter with a frequency band from 90 Hz to 10 kHz, and therefore can be at least diminished. Additionally or alternatively to the diminution of the noises by filtering, it is also conceivable that the noises influencing the at least one tone property are actively suppressed or extinguished. The active suppression or extinction of the noises may be based on principles of active noise suppression (often also designated as active noise extinction, active noise compensation, active noise cancellation (ANC) or active noise reduction (ANR)), as will be described further below.

The speech data appertaining to the person and serving for speech communication on board the means of transport can be adapted on the basis of information about the average human sense of hearing. Correspondingly, the adapting of the speech data appertaining to the person and serving for speech communication on board the means of transport may include a step of adapting the speech data on the basis of information about the average human sense of hearing. The human audition is generally able to perceive sounds within a defined level range or loudness-level range depending on the frequency. The range of the sound-pressure level or sound intensity depending on the frequency, within which the human audition is able to perceive sounds, is designated as the auditory sensation area. Expressed otherwise, the auditory sensation area (also called the range of audibility or auditory field) is that frequency range and level range of sound that can be perceived by the human audition. The auditory sensation area may also describe the individual hearing capacity of a single person. The auditory sensation area of a human being is situated approximately between about 0.02 kHz and approximately 20 kHz. More precisely, the auditory sensation area is bounded by the lowest frequency audible to a human being, at about 16 Hz to 21 Hz, and by the highest audible frequency, at about 16 kHz to 19 kHz. A human being hears best between 1 kHz and 5 kHz. It is here that most sounds of spoken language also appear.

Information about the average hearing capacity of a human being can accordingly be taken into account for the purpose of adaptation. Correspondingly, the speech data appertaining to the person and serving for speech communication on board the means of transport can be adapted in such a manner that frequencies readily perceptible by the human audition are adapted more elaborately, whereas frequencies that are not perceptible or barely perceptible are not taken into much account in the course of the adaptation, for example are removed as such.

The adapting of the speech data appertaining to the person and serving for speech communication on board the means of transport may include a step of adapting the speech data on the basis of information about the means of transport. For example, an adapting of the speech data may be effected on the basis of information about the type of the means of transport. The information about the type of the means of transport may generally specify which type of means of transport it is question of, for example an aircraft or a train. Additionally or alternatively, the information about the type of the means of transport may specify the precise type, such as, for example, the precise series of the means of transport, such as, for example, aircraft Airbus® A340®. For example, the loudness level of the speech data can be increased more intensely if it is a question of a, more likely, loud type of means of transport, and can be increased less intensely if it is a question of a quieter type of means of transport. Additionally or alternatively, an operating state of the means of transport can be taken into consideration. In the case of an aircraft, the operating state may specify whether the aircraft is located on the ground or in the air. For example, it may be assumed that flight noises are greater in the air than on the ground. Correspondingly, in the case of an aircraft located in the air, the level of the speech data can be increased. Additionally or alternatively, an adapting of the speech data may be based on a seating distribution in the means of transport. The seating distribution may, for example, be stored in advance in the device executing the method. Additionally or alternatively, the adapting of the speech data may include an adapting step on the basis of a number of passengers in the means of transport. The number of passengers may, for example, be entered by a flight attendant, or otherwise, into the device executing the method. Additionally or alternatively to this, a passenger distribution in the means of transport can be taken into consideration. The passenger distribution can, for example, be determined in the device executing the method with the aid of seating reservations, or can be entered into the device.

It is conceivable that the information about the means of transport is ascertained in advance by measurement with the aid of a test signal. For example, consequences and/or effects of a defined seating distribution and/or of a defined number of passengers and/or of a defined passenger distribution in the means of transport can be measured with the aid of one or more test signals. The ascertained information can be saved appropriately and later retrieved where appropriate, in order to draw inferences as to consequences and/or effects of a current seating distribution and/or of a current number of passengers and/or of a current passenger distribution in the means of transport, and to take them into consideration in the course of the adaptation. For example, information about resonances in the cabin of the means of transport and/or about interference noise in the cabin of the means of transport can be acquired with the aid of the measurements. By way of test signal, sonic signals of various, for example, also variable, levels and/or frequencies can be used. For example, with the aid of one or more measurements the information about the means of transport—such as, for example, information about a background noise that is present in the cabin of the means of transport, and/or information about the resonance in the cabin of the means of transport—can be ascertained and can be stored in a database.

The method may furthermore include a step of ascertaining information about the quality of the speech communication at one or more receiving locations on board the means of transport. The quality of the speech communication can be ascertained in various ways. For example, there are objective and subjective assessments for speech quality. The International Telecommunication Union (ITU) has developed a method for the objective assessment, the so-called E-model, which has been specified in standard G.107 and is based on reproducible disturbance variables. The objective methods for assessing speech quality include methods for measuring the noise margin, the echo measurement, the perceptual evaluation of speech quality (PESQ), the perceptual speech quality measurement (PSQM), perceptual analysis measurement system (PAMS) and multimedia perception assessment center (MPAC). The subjective assessment can use mean-opinion-score (MOS) values as the arithmetic mean of individual assessments, or methods for assessment of the speech quality that have been refined by the ITU-T in Recommendations Q.800 and Q.830.

Irrespective of the measures employed for ascertaining the speech quality, the speech data appertaining to the person and serving for speech communication on board the means of transport can be adapted on the basis of the ascertained information about the quality of the speech communication at the one or more receiving locations. It is, for example, conceivable that during the speech communication the quality at the one or more receiving locations is ascertained once or several times, for example continuously, and correspondingly at each of the one or more receiving locations the speech data are adapted individually on the basis of the ascertained information about the quality of the speech communication at the one or more receiving locations. For example, the speech communication at the one or more receiving locations can firstly be acquired. This acquisition may be effected in various ways. For example, special microphones may be employed. The microphones may, for example, cover a frequency range that is as broad as possible or as specific as possible. From the information acquired at the one or more receiving locations, the speech quality can then be ascertained correspondingly and can be used for adapting the speech data. For example, at a first receiving location in the means of transport a first quality of the speech communication, for example, a good quality of the speech communication, can be ascertained. At a second receiving location a second quality of the speech communication, for example, a poorer quality, can be ascertained. The speech data are then adapted less intensely or not at all at the first receiving location, for example, since the quality is good anyway. Alternatively, the quality that is already good anyway can be improved further by slight adaptation. The speech data are adapted at the second receiving location in such a manner, for example, that the quality of the speech communication at the second receiving location has been improved and, for example, at least almost attains the quality of the speech communication at the first receiving location.

By virtue of the individual adaptation of the speech quality at the one or more receiving locations, an at least almost equally good speech quality can be attained at each of the one or more receiving locations. Furthermore, by reason of the ascertainment of the quality of the speech communication at the one or more receiving locations, and by reason of the adaptation, based thereon, of the speech data, the aforementioned measurements of the information about the means of transport with the aid of one or more test signals can be dispensed with.

The method may furthermore include a step of ascertaining information about noises or interference noise at one or more acquiring locations on board the means of transport. The noises may also be designated as background noise effects, and the interference noise may also be designated as background noise. In the following, for the purpose of simplification, ‘noises’ will always be referred to consistently. Special microphones, for example, may be arranged at the one or more acquiring locations for the purpose of acquiring the noises. The acquired noises can then be evaluated appropriately in order to ascertain information about the noises. The microphones may, for example, cover a frequency range that is as broad as possible or as specific as possible. For example, the microphones may be microphones that are arranged at the aforementioned one or more receiving locations. In this case the one or more acquiring locations coincide with the one or more receiving locations. The microphones may be located at differing locations in the means of transport. Purely by way of example, let it be mentioned here that the microphones arranged at the one or more acquiring locations may be arranged in regions above the seats, in window regions or such like.

The method may furthermore include a step of generating at least one noise anti-signal for diminishing the noises at the one or more acquiring locations on board the means of transport on the basis of the ascertained information about the noises at the one or more acquiring locations. The at least one anti-noise signal may, for example, have been formed in such a manner that it is able to extinguish, for example by means of destructive interference, the noises at the one or more acquiring locations. For example, the at least one anti-noise signal may have been formed in such a manner that it at least almost exactly corresponds to the (disturbing) noises with opposite polarity.

The adapting of the speech data appertaining to the person and serving for speech communication on board the means of transport may accordingly include a step of diminishing the noises at the one or more acquiring locations on board the means of transport with the aid of the generated at least one noise anti-signal. The noises may, for example, also be extinguished at the one or more acquiring locations with the aid of the generated at least one noise anti-signal. In the case of the anti-noise signal for extinguishing a noise at an acquiring location it may be a question, for example, of a signal that exhibits at least almost the same amplitude (the same level) in dB as the acquired noise but in relation to the acquired noise has been phase-shifted, for example by 180 degrees, in order to guarantee an extinction of the noise. Irrespective of the precise generation of the anti-noise signal, the magnitude of the amplitude of the anti-noise signal may at least almost correspond to the magnitude of the amplitude of the acquired noise, but the sign of the amplitude may have been reversed.

The diminution of the noises may be effected individually as described previously with reference to the adaptation of the speech data on the basis of the ascertained information about the quality of the speech communication at the one or more receiving locations. For example, the noises in the means of transport can be reduced in differing ways, taking into consideration the information about the noises at various locations. Alternatively, a uniform adaptation for the entire means of transport is conceivable. This means that the noise suppression can be effected uniformly for the entire means of transport or for various locations or regions of the means of transport individually.

In the course of the individual noise suppression, the information about the noises at the one or more acquiring locations can be used in order to suppress the noises at various locations or regions of the means of transport individually. For example, for a first acquiring location in the means of transport a first noise level, for example, a low noise level, can be ascertained. For a second acquiring location a second noise level, for example, a high noise level, can be ascertained. For the first acquiring location, an anti-noise signal of smaller amplitude, for example, is then generated which may have been or may be appropriately directed so as to oppose the first noise level. For the second acquiring location, an anti-noise signal of larger amplitude, for example, is ascertained, which may have been or may be appropriately directed so as to oppose the second noise level.

In order to guarantee that the at least one anti-noise signal does not have a negative influence on the speech data serving for speech communication, various approaches are conceivable. For example, the frequency range of the speech data can be protected. Expressed otherwise, it can, for example, be guaranteed that no noise compensation takes place within the frequency range of the speech data. The noise compensation is permitted, for example, only within frequency ranges lying outside the frequency range of the speech data. The frequency range of the speech data can be ascertained individually, as described above. Other desired acoustic signals, such as instruction tones or such like, can also be protected, like the speech data, against an influence exerted by the anti-noise signals (for example, for the period of the output of the desired acoustic signals).

It is likewise possible to protect desired acoustic signals, the frequency properties of which are unknown, against an influence exerted by the anti-noise signals. For this purpose, such an unknown acoustic signal, such as music, for example, can firstly be analyzed and can actually be output, for example, to the cabin of the means of transport, only with a temporal delay, such as, for example, within the millisecond range or within the range of one or more seconds. By virtue of the analysis, frequency ranges to be protected of the unknown acoustic signal can, for example, be determined. The frequency ranges to be protected can be taken into consideration appropriately, for example omitted, in the course of the noise compensation. This means that the at least one anti-noise signal can be generated by taking into consideration the defined frequency ranges to be protected, so that the anti-noise signal does not influence the desired acoustic signal. The aforementioned temporal delay makes it possible to execute the analysis and generation of the anti-noise signal before or while the desired acoustic signal is actually output, taking the temporal delay into consideration. The analysis together with temporal delay can also be used for known acoustic signals.

Furthermore, the method may include a step of storing of least one tone property of recorded speech data appertaining to at least one person. For example, speech data appertaining to several persons may be recorded in advance. In the case of an aircraft, speech data appertaining to the aircraft personnel, for example, such as flight attendants and/or pilots for example, can be recorded. The recorded speech data can, for example, be stored in the device executing the method. Additionally or alternatively to this, the speech data can be stored locally on a storage medium such as a USB stick and can be loaded into the device by the aircraft personnel when required. Irrespective of the location of storage and the storage medium of the recorded speech data, the latter can be transmitted in wireless or hard-wired manner to the device executing the method.

The information relating to the at least one tone property can be evaluated by the device executing the method, or already in advance in other suitable systems. For example, information relating to the at least one tone property can be ascertained for several persons from the recorded speech data. The ascertained information can then be stored appropriately in the device or in a suitable storage medium. Irrespective of the location of storage and the storage medium of the ascertained information, the latter can be transmitted in wireless and/or hard-wired manner to the device executing the method. In the case of storage on a storage medium, the information needed can be loaded into the device when required and, for example, stored. It is, for example, conceivable that information relating to several tone properties is stored for several persons.

For example, the method may furthermore include a step of recognizing a person on the basis of information identifying the person. The information identifying the person may comprise biometric data, voice data, identity-card data or such like. As a simple realization, a password and/or a personal identification number (PIN) are also conceivable. For example, the person can be recognized on the basis of entered information identifying the person. With respect to the recognized person, information relating to the at least one tone property can then be obtained, such as, for example, retrieved.

In the case of an aircraft, for example, information relating to the at least one tone property for several persons of the personnel of an airline, for example, for the entire flying personnel of an airline, may have been stored in a database. For the flight crew and/or cabin crew of a pending flight, the appropriate information relating to the at least one tone property can then be transmitted, for example, in a wireless manner, to the device executing the method and can be used therein when required for adapting the speech data of a speech communication. It is similarly possible to update already available information relating to the at least one tone property in wireless and/or hard-wired manner. It is, for example, conceivable that prior to take-off of the aircraft the information about the at least one tone property for the flight crew and/or cabin crew taking part in the flight is transmitted to the device. For a speech communication implemented before, during or after the flight and for potentially implemented adaptations of the speech data, the information about the at least one tone property is then available on board the aircraft.

A second aspect relates to a computer program with program-code means, which, when it has been loaded into a computer or into a processor (for example, a microprocessor, microcontroller or digital signal processor (DSP)) or is running on a computer or processor (e.g., a microprocessor, microcontroller or DSP), induces the computer or processor (e.g., microprocessor, microcontroller or DSP) to execute one or more steps or all the steps of the method previously described. In addition, a program-storage medium or computer-program product with the aforementioned computer program is made available.

A third aspect relates to a device for adapting speech data serving for speech communication on board a means of transport. The device comprises an obtaining component and at least one adapting component. The obtaining component is configured to obtain information relating to at least one tone property, the information relating to the at least one tone property having been derived from recorded speech data appertaining to a person. The at least one adapting component is configured to adapt speech data appertaining to the person and serving for speech communication on board the means of transport on the basis of the obtained information about the at least one tone property.

The obtaining component may also be designated as the receiving component, which is configured to receive the information relating to the at least one tone property. The device may have been integrated into communication systems existing on board the means of transport.

The obtaining component and/or the at least one adapting component may each have been arranged jointly at one location or separately at differing locations. It is furthermore conceivable that, for example, each of the at least one adapting component may have been arranged at a differing location in the means of transport. For example, each of the at least one adapting component may have been arranged in a passenger-servicing module of the means of transport. At passenger-servicing modules of such a type various comfort elements and operating elements for individual provision of, for example, air, light, music, oxygen, information or such like to passengers in the passenger compartments (also called cabins) may have been arranged. A loudspeaker that is present at a servicing module of such a type may be connected to one of the at least one adapting component. In this way, the speech data for each passenger can be adapted individually.

Furthermore, the computer program according to the second aspect may, for example, have been stored in the device according to the third aspect and may induce the device to execute one or more or all of the aspects and/or steps, previously described, of the method according to the first aspect.

A fourth aspect relates to a means of transport, for example an aircraft, with a device described herein.

Even though some of the aspects described above were described with reference to the method, these aspects may also be realized in corresponding manner in the device, in the means of transport or in a computer program implementing the method. Similarly, the aspects described above with reference to the device may also be realized as a method or as a computer program implementing the method.

### BRIEF DESCRIPTION OF THE DRAWINGS

The present disclosure will be elucidated further on the basis of Figures. These Figures show schematically:

FIG. 1, a block diagram of a device for adapting speech data, according to a first embodiment;

FIG. 2, a block diagram of a device for adapting speech data, according to a second embodiment;

FIG. 3, a flow chart for illustrating a method for adapting speech data, according to a first embodiment, which may be implemented in the device according to the first embodiment from FIG. 1 and/or in the device according to the second embodiment from FIG. 2;

FIG. 4, an aircraft as an example of a means of transport with a device for adapting speech data, according to the first embodiment from FIG. 1 and/or according to the second embodiment from FIG. 2;

FIG. 5, a flow chart for illustrating a method for adapting speech data, according to a second embodiment, which may be implemented in the device according to the first embodiment from FIG. 1, in the device according to the second embodiment from FIG. 2, and/or on board the means of transport according to FIG. 4; and

FIG. 6, an aircraft as an example of a means of transport with a device for adapting speech data, according to the first embodiment from FIG. 1 and/or according to the second embodiment from FIG. 2; and

FIG. 7, a flow chart for illustrating a method for adapting speech data, according to a third embodiment, which may be implemented in the device according to the first embodiment from FIG. 1, in the device according to the second embodiment from FIG. 2, and/or on board the means of transport according to FIG. 6.

### DETAILED DESCRIPTION OF THE PREFERRED EMBODIMENTS

In the following, without being restricted thereto, specific details will be presented in order to provide a complete understanding of the present disclosure. To a person skilled in the art, however, it is clear that the present disclosure can be used in other embodiments which may differ from the details presented below.

To a person skilled in the art it is clear that the explanatory remarks presented below may have been or may be implemented using hardware circuits, software means or a combination thereof. The software means may be linked with programmed microprocessors or with a general computer, with an ASIC (application-specific integrated circuit) and/or DSPs (digital signal processors). In addition, it is clear that even when the following details are described with reference to a method these details may also have been realized in a suitable device unit, in a computer processor or in a memory connected to a processor, the memory having been provided with one or more programs that implement the method when they are executed by the processor.

The embodiments will be described in the following purely by way of examples, for the most part with reference to an aircraft as an example of a means of transport. Furthermore, by way of example it will for the most part be assumed in the following that in the case of the components and units shown in the Figures it is a question of those of an aircraft. The components described below are, however, not restricted to use in an aircraft but may also have been or be arranged in other means of transport, such as trains, buses or ships. Furthermore, spoken announcements on board an aircraft that have been implemented with the aid of defined communication systems will be described below, purely by way of example, for the purpose of illustrating the present disclosure.

On board an aircraft, spoken announcements can be implemented with the aid of defined communication systems, with the aid of which the spoken announcements are output in the cabin of the aircraft and, as a result, can be heard by the passengers. Communication systems of such a type have strengths and weaknesses. In any case, they change the tone of voice of a speaker. In order to make the voice of the speaker appear as euphonious as possible (e.g., as close as possible to the actual tone of the speaker), various adaptations of settings that are possible in such a communication system can be implemented, as will be described below. As will further be described below, the settings of the communication system can be adapted (changed) manually on the basis of defined acquired information or on the basis of information concerning the human audition.

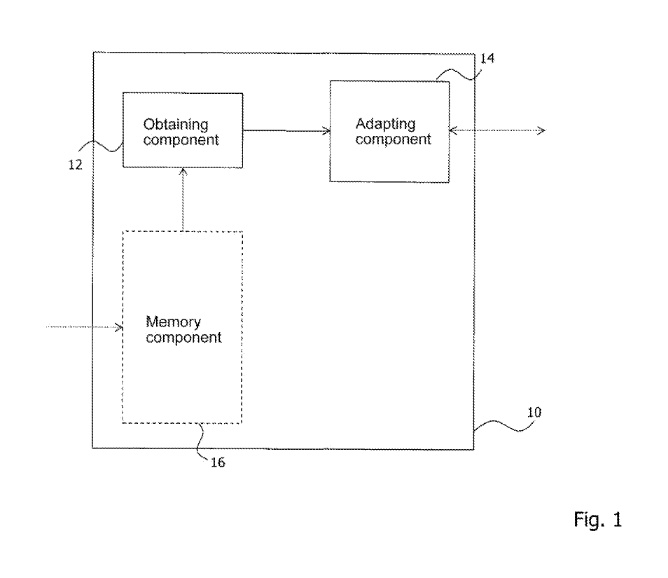

FIG. 1 shows a device 10 for adapting speech data serving for speech communication on board a means of transport, according to a first embodiment. The device 10 comprises an obtaining component 12 and an adapting component 14. Furthermore, the device 10 may include an optional memory component 16. The obtaining component 12 is configured to obtain information relating to at least one tone property. For example, the obtaining component 12 may obtain the information relating to the at least one tone property from the memory component 16, such as, for example, retrieve it from the memory component 16 or read it out from the memory component 16. Alternatively, the information relating to the at least one tone property may be given directly to the obtaining component 12 without interposition of the memory component 16. In the obtaining component 12 an interim storage of the information can be implemented. The information relating to the at least one tone property has been derived from recorded speech data appertaining to a person. The adapting component 14 is configured to adapt speech data appertaining to the person and serving for speech communication on board a means of transport on the basis of the obtained information about the at least one tone property.

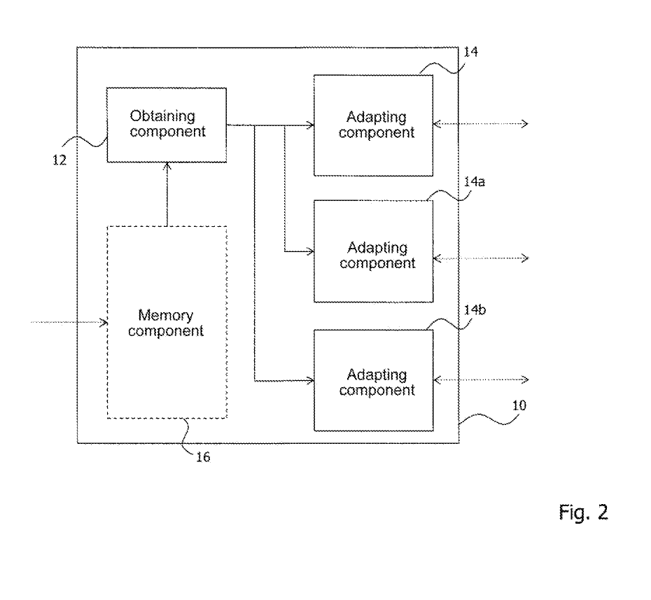

FIG. 2 shows schematically a device 10 for adapting speech data serving for speech communication on board a means of transport, according to a second embodiment. The device 10 comprises an obtaining component 12 and several adapting components 14, 14a, 14b. Even though only three adapting components 14, 14a, 14b have been shown by way of example in FIG. 2, the device 10 may comprise any plurality of adapting components. Furthermore, the device 10 may include an optional memory component 16. The obtaining component 12 and the memory component 16 may have been designed like the corresponding components from FIG. 1. Furthermore, each of the adapting components 14, 14a, 14b may have been designed like the adapting component 14 of the device from FIG. 1.

In contrast to the device from FIG. 1 according to the first embodiment, the several adapting components 14, 14a, 14b of the device from FIG. 2 are arranged at differing locations in the means of transport, namely, according to the example, at three different locations. Each of the adapting components 14, 14a, 14b may, for example, have been assigned to a subset of the seats of the means of transport, such as a row of seats or only one seat. With the aid of the several adapting components 14, 14a, 14b a more individual adaptation can be effected, as will be described below.

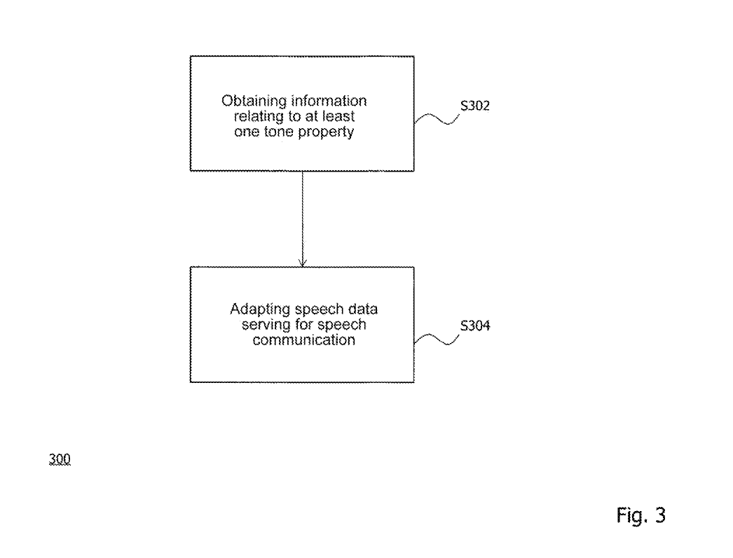

In general, the method represented in FIG. 3 according to the first embodiment can be executed both in the device 10 according to the first embodiment from FIG. 1 and in the device 10 according to the second embodiment from FIG. 2. Accordingly, in step S302 firstly information relating to at least one tone property is obtained from the obtaining component 12. The information relating to the at least one tone property has been derived from recorded speech data appertaining to a person. Subsequently, in step S304 speech data appertaining to the person and serving for speech communication on board the means of transport are adapted by the adapting component 14 on the basis of the obtained information about the at least one tone property.

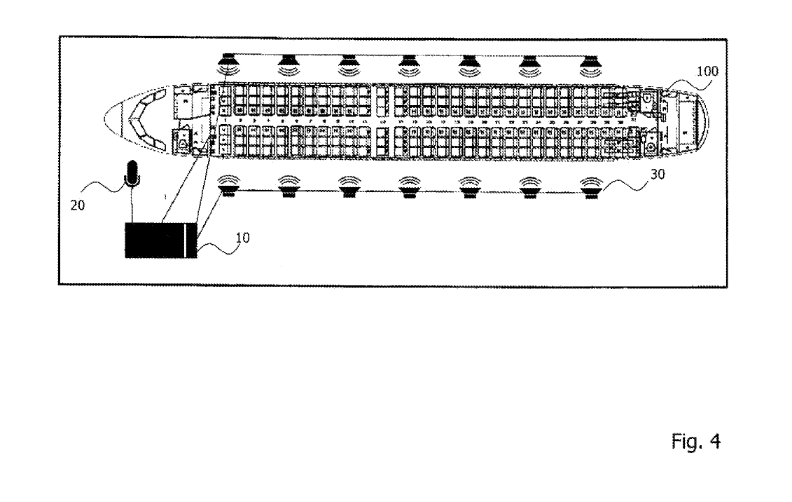

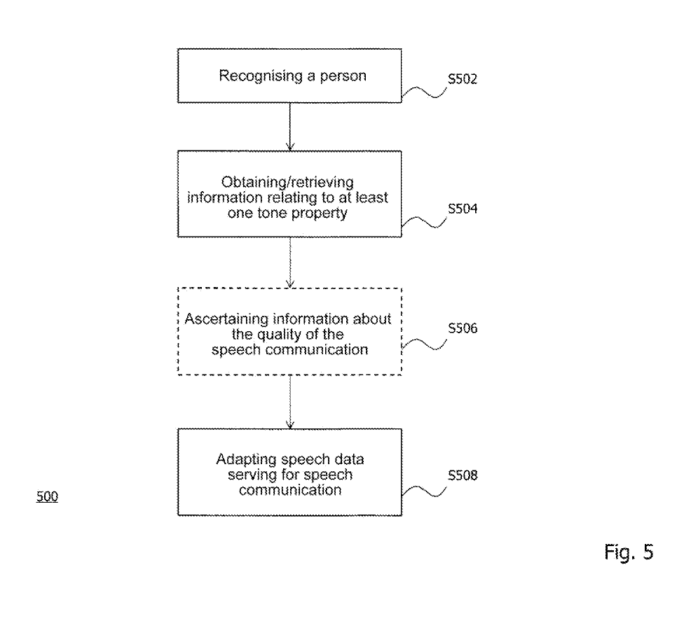

The devices according to the embodiments from FIGS. 1 and 2 will be further elucidated below with reference to FIGS. 4 and 5. FIG. 4 shows schematically how the device 10 may have been arranged on board an aircraft 100 as an example of a means of transport. Furthermore, FIG. 4 shows that a microphone 20 may be connected to the device 10, and several loudspeakers 30 may be connected to the device 10, for example via a bus system. With the aid of the microphone 20, spoken announcements, for example, may be made by the personnel of the aircraft. The loudspeakers 30 have been arranged on board the aircraft 100. The arrangement of the loudspeakers 30 can be chosen flexibly, for example at the sides of the interior space of the cabin, above the seats of the aircraft 100, or such like. Purely by way of example, seven loudspeakers 30 per side of the aircraft 100 have been shown. However, any plurality of loudspeakers 30 per side of the aircraft 100 may have been arranged, for example one loudspeaker 30 per row of seats or even one loudspeaker per seat. In the last-mentioned case a loudspeaker arranged anyway in a passenger-servicing module above each seat can, for example, be used as loudspeaker 30.

Firstly, specific configurations of the device 10 according to the first embodiment from FIG. 1 will be elucidated further with reference to FIGS. 4 and 5.

A flight attendant who would like to make a spoken announcement identifies himself/herself to the device 10. As a result, the flight attendant can be recognized (step S502). This can be effected, for example, by automatic recognition of identification-card data. Alternatively, the flight attendant can enter a PIN. It is furthermore conceivable that the flight attendant is recognized automatically with the aid of biometric data or his/her voice. The voice recognition can be verified, for example, by means of a PIN input. After recognition of the flight attendant in step S502, the obtaining component 12 obtains information relating to at least one tone property (step S504). For this purpose the device 10 examines, for example, whether information relating to at least one tone property with respect to this person has been stored in one of the memories, for example, in the memory component 16 of the device 10. This information relating to the at least one tone property may, for example, have been acquired in advance from recorded speech data. Alternatively to the searching for the information in a memory, it is also conceivable that the information relating to the at least one tone property is, for example, loaded into the device 10 in advance. For example, the flight attendant himself/herself may load into the device 10 the information relating to the at least one tone property with the aid of a storage medium such as a USB stick. Similarly, it is conceivable that for several persons of the flight crew and/or cabin crew of an airline the information relating to the at least one tone property has been stored in a database (outside or inside the aircraft). For example, for the relevant personnel, such as the flight crew and/or cabin crew taking part in the flight, in each instance the information relating to the at least one tone property is transmitted to the device 10, more precisely to the obtaining component 12 of the device 10, prior to a flight to be implemented. The transmission may be effected in wireless or hard-wired manner. In the case of a wireless transmission, the obtaining component 12 may include, for one or more different communication standards, corresponding modules for wireless transmitting and/or receiving of data.

Irrespective of how the information relating to the at last one tone property has been obtained from the obtaining component 12 in step S504, the information can, when required, be forwarded to the adapting component 14 or retrieved from the latter. This is the case, for example, if the flight attendant would like to make a spoken announcement. During the implementing of the spoken announcement, the adapting component 14 can adapt the speech data of the spoken announcement with the aid of the information relating to the at least one tone property (S508). For example, the at least one tone property may include a frequency range, and the information relating to the at least one tone property may specify the frequency range of the voice of the recognized person or identified person in the recorded speech data. This specified frequency range can now be used in order to adapt the speech data of the spoken announcement. It is, for example, conceivable that frequencies are recognized that lie outside the customary frequency range and, for example, exceed a permissible limiting value. The adapting component 14 may in this case assume that it is a question here of disturbing noises and not of the speech data of the spoken announcement itself. Such disturbing noises can be suppressed. As a simplest realization, it is conceivable that the adapting component 14 uses a band-pass filter that has been tuned to the specified frequency range, such as, for example, a band-pass filter with a frequency band corresponding to the specified frequency range. The frequencies lying outside this frequency range are filtered out by the band-pass filter.

This measure improves the speech quality.

In the course of a previously described adaptation of the speech data, the speech quality at the respective loudspeakers 30 may, however, be variable. There may be various reasons for this, such as, for example, the distribution of the passengers in the aircraft 100 (e.g., by reason of the muffling properties of the passengers) or the seating distribution in the aircraft 100 (e.g., by reason of the muffling and/or reflecting properties of the seats). In order to take effects of such a type into consideration, measurements in the aircraft 100 can be carried out, for example, in a preliminary stage, and the results thereof can be stored appropriately in the device 10. For example, with the aid of test signals for various seating arrangements and passenger distributions in the aircraft 100 in each instance a measurement can be carried out. With the aid of the measurements, influences of specific seating arrangements or passenger distributions in the aircraft 100 on the speech communication can be predicted and can be stored in the device 10.

These ascertained influences can be used appropriately in step S508 in order to adapt the speech data appropriately for the current circumstances, such as, for example, the current number of passengers and/or the current distribution of the passengers in the aircraft 100. For example, the current passenger distribution in the aircraft 100 may be known on the basis of the seat reservations. If, for example, distinctly fewer passengers are sitting in the front region of the aircraft 100 than in the rear region, sound-waves in the front region will be attenuated less strongly than in the rear region. By taking these effects into consideration, the adapting component 14 can adapt the speech data, for example by the speech data being adapted in such a way that they are at least similarly well intelligible both in the front region and in the rear region.

In the case where use is made of the device 10 according to the second embodiment from FIG. 2, the ascertained information about the effects can be used in order to carry out an individual adaptation of the speech data with the aid of the several adapting components 14, 14a, 14b. For example, an individual adaptation of the speech data can be effected at each of the adapting components 14, 14a, 14b by taking the passenger distribution in the aircraft 100 into consideration.

With the aid of the device 10 according to the second embodiment from FIG. 2 the speech quality can, where appropriate, be improved still further, but at least more individually. For this purpose, the optional step S506 can additionally be carried out. For the more individual adaptation, the device 10 according to the second embodiment includes a plurality of adapting components 14, 14a, 14b at various locations in the aircraft. Each of the adapting components 14, 14a, 14b may respectively be present at one of the loudspeakers 30 or may have been connected to one of the loudspeakers 30. Alternatively, each of the adapting components 14, 14a, 14b may be present at a subset of the loudspeakers 30 or may have been connected to a subset of the loudspeakers 30. Each of the adapting components may furthermore have been connected to a component for recording the output speech data, such as a microphone for example, or may include such a component.

For the purpose of more individual adaptation, prior to the adaptation of the speech data in step S508, correspondingly in step S506 firstly the quality of the speech communication at many or all of the loudspeakers 30 can be ascertained. This means that at each adapting component 14, 14a, 14b the speech quality foreseeably experienced at the location of the respective adapting component 14, 14a, 14b or at the location of the loudspeaker 30 connected to the respective adapting component 14, 14a, 14b can be ascertained individually. For this purpose, firstly the speech data that have been output from the loudspeakers 30 can be acquired at the one or more receiving locations by microphones or other components. The acquired information can respectively be forwarded to the associated adapting component 14, 14a, 14b (this has been illustrated in FIG. 2 by the double-headed arrows). In the adapting components 14, 14a, 14b the acquired information can be used for ascertaining the speech quality at the one or more receiving locations. On the basis of the ascertained speech quality, an individual adaptation can then be effected.

If, for example, it is assumed that a poorer speech quality was ascertained at adapting component 14 than at adapting component 14b, adaptations improving the speech quality in respect of the speech data can be carried out by means of adapting component 14. If the ascertained speech quality changes in the course of the speech communication, for example, by reason of changed external influences, so that a better speech quality is ascertained at adapting component 14 than at adapting component 14b, adaptations improving the speech quality in respect of the speech data can be carried out by means of adapting component 14b. The ascertainment of the speech quality can be carried out repeatedly, for example continuously, during the speech communication. The same holds for the adaptation of the speech data.

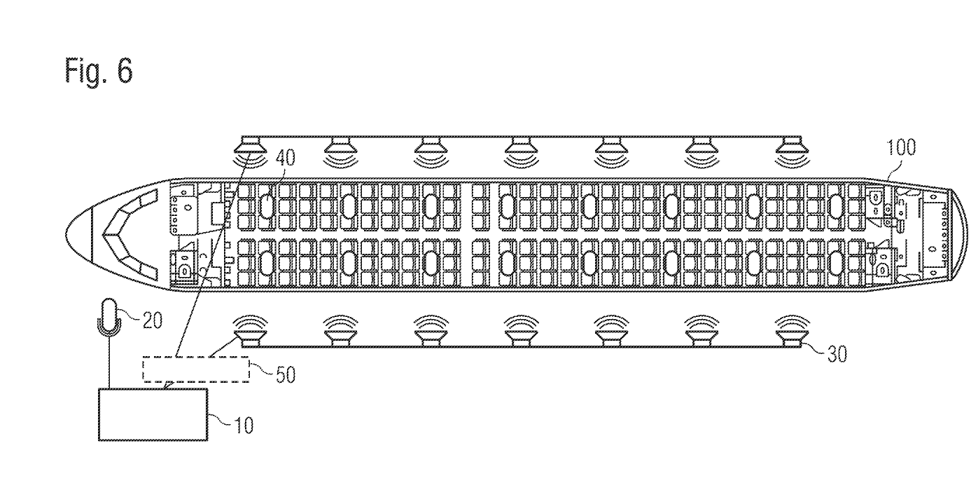

FIG. 6 shows schematically how the device 10 may have been arranged on board an aircraft 100 as an example of a means of transport. In contrast to the arrangement from FIG. 4, in FIG. 6 several microphones 40 have been shown. By way of example, sixteen microphones 40 (eight per side) have been shown. However, any number of microphones 40 may find application. Purely by way of example, in FIG. 6 one microphone 40 per side has been arranged for several rows. Alternatively, however, it is also conceivable that one microphone 40 is present per row or per seat. The microphones may, for example, have been arranged respectively above the seats, such as, for example, in a passenger-servicing module. In the case of the microphones 40 it may be a question, for example, of those mentioned with reference to FIG. 4, of microphones arranged at the one or more receiving locations, or of other (e.g. additional) microphones. If in the case of the microphones 40 from FIG. 6 it is a question of those mentioned with reference to FIG. 4, of microphones arranged at the one or more receiving locations, the method for adapting speech data according to the second embodiment from FIG. 5 can be executed with the arrangement from FIG. 6.

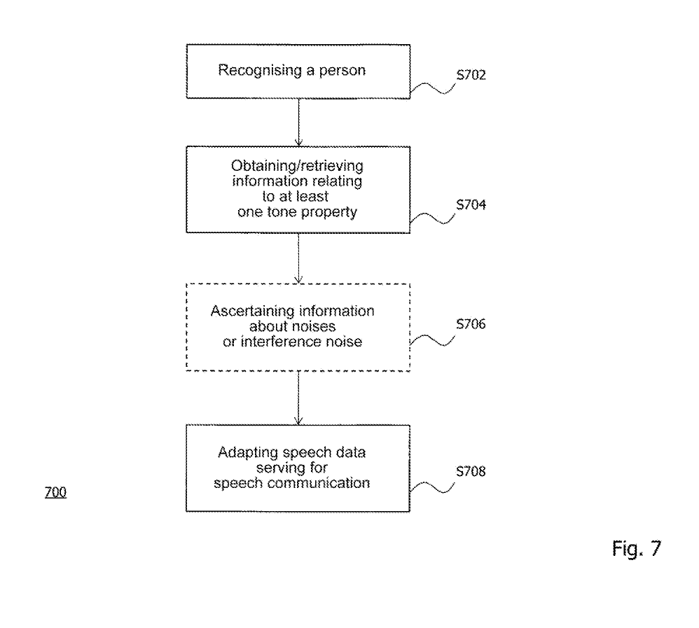

Additionally or alternatively, with the aid of the arrangement from FIG. 6 the method for adapting speech data according to the third embodiment from FIG. 7 can be executed. The method according to the third embodiment from FIG. 7 differs from the method according to the second embodiment from FIG. 5 in that, instead of step S506 (ascertaining information about the quality of the speech communication), step S706 (ascertaining information about noises or interference noise) is executed. Correspondingly, the adapting steps S508, S708 also differ from one another. With respect to steps S702 and S704, reference is accordingly made to the above remarks with reference to steps S502 and S504.

In step S706, noises in the means of transport are acquired with the aid of the microphones 40. One of the several adapting components 14, 14a, 14b from FIG. 2 may have been connected to each microphone 40. Information about the acquired noises can be ascertained from the acquired noises in each of the adapting components 14, 14a, 14b. For example, the amplitude of the noises within a defined frequency range and/or the amplitude of the noises over a certain course of time can be ascertained. For the sake of simplicity, noises and the amplitude of the noises will always be referred to in the following.

The ascertained information about the noises in the means of transport can then be used in step S708 for adapting speech data serving for speech communication. For example, the adapting components 14, 14a, 14b can generate selectively defined anti-noise signals which are directed so as to oppose the acquired noises and serve for extinction thereof. Purely by way of example, by each of the adapting components 14, 14a, 14b an anti-noise signal is respectively generated, the amplitude of which at least almost corresponds in numerical value to the associated noise and at the same time exhibits an inverse sign. Even though it is described herein, purely by way of example, that the adapting components 14, 14a, 14b generate the anti-noise signals, the anti-noise signals can also be generated in an external unit, such as a device connected to the device 10, and forwarded to the loudspeakers 30 for output.

The adapting components 14, 14a, 14b (or alternatively a different unit, for example, also an external unit) may furthermore protect the speech data by generating no anti-noise-signal components for the frequency range of the speech data. Expressed otherwise, no anti-noise signal is generated for the frequency range of the speech data. The generated anti-noise signals can then be forwarded to the loudspeakers 30 for output. The anti-noise signals that have been output from the loudspeakers 30 at least almost extinguish the noises in defined regions of the aircraft, such as, for example, uniformly in the aircraft. Other desired acoustic signals can also be protected, like the speech data, against an influence exerted by the anti-noise signals. For example, an information tone that draws attention to the fact that a spoken announcement will be made can be protected by virtue of the fact that the frequency range thereof is not influenced by the generated anti-noise signals.

It is likewise possible to protect desired acoustic signals, the frequency properties of which are unknown, against an influence exerted by the anti-noise signals. As an example, let music be mentioned here. Such an acoustic signal can be analyzed, for example prior to play-back or during play-back in the cabin of the aircraft. In this analysis the frequency range to be protected of the acoustic signal is ascertained by the adapting components 14, 14a, 14b (or by another unit). The anti-noise signal is then generated in such a manner that the frequency range to be protected of the acoustic signal is not influenced. In order to prevent the acoustic signal from being played back before or during the analysis, an optional delay component 50 has been provided which temporally delays the playback of the acoustic signal in such a manner that the analysis has been concluded and the anti-noise signal was generated appropriately. The temporal delay may, for example, have been synchronized with the analysis-time, i.e., the temporal delay may have been set in such a way that in each instance a part of the acoustic signal was analyzed, the anti-noise signal was generated appropriately and output. In this way, a generation and output, which does not negatively influence the acoustic signal, of the anti-noise signal can take place continuously, during the delayed output of the acoustic signal.

With the aid of the arrangement from FIG. 6 it is therefore possible to adapt selectively the speech data serving for speech communication for the locations at which noises arise to an increased extent. This is achieved in that noises influencing the speech data are actively suppressed. According to the example described with reference to FIGS. 6 and 7, this is achieved by virtue of the fact that anti-signals, so-called anti-noise signals, directed so as to oppose the noises, are generated which at least diminish the noises even if they do not extinguish them. The tone of the speech communication is improved thereby.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for adapting speech data serving for speech communication on board a means of transport, the method comprising:
obtaining information relating to at least one tone property, the information relating to the at least one tone property having been derived from recorded speech data appertaining to a person; and
adapting speech data appertaining to the person and serving for speech communication on board the means of transport on the basis of the obtained information about the at least one tone property.

2. The method according to claim 1, the method including a step of adapting the speech data serving for speech communication on board the means of transport such that information relating to the at least one tone property of the speech data serving for speech communication on board the means of transport is at least approximated to the information, derived from the recorded speech data appertaining to the person, relating to the at least one tone property.

3. The method according to claim 1, wherein the adapting of the speech data appertaining to the person and serving for speech communication on board the means of transport includes at least a step of diminishing noises influencing the at least one tone property.

4. The method according to claim 3, wherein said step of diminishing noises comprises a step of diminishing noises outside the at least one tone property.

5. The method according to claim 1, wherein the adapting of the speech data appertaining to the person and serving for speech communication on board the means of transport includes a step of adapting the speech data on the basis of information about the average human sense of hearing.

6. The method according to claim 1, wherein the adapting of the speech data appertaining to the person and serving for speech communication on board the means of transport includes a step of adapting the speech data on the basis of information about the means of transport.

7. The method according to claim 1, wherein the adapting of the speech data appertaining to the person and serving for speech communication on board the means of transport includes a step of adapting the speech data on the basis of information about at least one of:
the type of the means of transport,
an operating state of the means of transport,
a seating distribution in the means of transport,
a number of passengers in the means of transport, and
a passenger distribution in the means of transport.

8. The method according to claim 1, the method further including the steps:
ascertaining information about the quality of the speech communication at one or more receiving locations on board the means of transport, and
adapting the speech data appertaining to the person and serving for speech communication on board the means of transport on the basis of the ascertained information about the quality of the speech communication at the one or more receiving locations.

9. The method according to claim 1, the method further including:
ascertaining information about noises at one or more acquiring locations on board the means of transport, and
generating at least one noise anti-signal for diminishing the noises at the one or more acquiring locations on board the means of transport on the basis of the ascertained information about the noises at the one or more acquiring locations.

10. The method according to claim 8, wherein the adapting of the speech data appertaining to the person and serving for speech communication on board the means of transport includes a step of diminishing the noises at the one or more acquiring locations on board the means of transport with the aid of the generated at least one noise anti-signal.

11. The method according to claim 1, wherein the at least one tone property comprises one or more of the following tone properties: a frequency range, a fundamental frequency, a dynamic range, a level, a duration, a degree of modulation, a loudness, a sharpness, a pitch, a roughness, a fluctuation strength, a tone content, a pulse content of the recorded speech data appertaining to the person.

12. The method according to claim 1, the method further including a step of storing at least one tone property of recorded speech data appertaining to at least one person.

13. The method according to claim 1, the method further including the steps:
recognizing a person on the basis of information identifying the person, and
retrieving information relating to the at least one tone property with respect to the recognized person.

14. A device for adapting speech data serving for speech communication on board a means of transport, the device comprising:
an obtaining component configured to obtain information relating to at least one tone property, the information relating to the at least one tone property having been derived from recorded speech data appertaining to a person; and
at least one adapting component configured to adapt speech data appertaining to the person and serving for speech communication on board the means of transport on the basis of the obtained information about the at least one tone property.

15. The device according to claim 14, wherein each of the at least one adapting component has been arranged at a differing location in the means of transport.

16. The device according to claim 15, wherein the adapting component is arranged in a passenger-servicing module of the means of transport.

17. A means of transport with a device for adapting speech data serving for speech communication on board a means of transport, the device comprising:
an obtaining component configured to obtain information relating to at least one tone property, the information relating to the at least one tone property having been derived from recorded speech data appertaining to a person; and
at least one adapting component configured to adapt speech data appertaining to the person and serving for speech communication on board the means of transport on the basis of the obtained information about the at least one tone property.
